(19) United States
(12) Patent Application Publication
(10) Pub. No.: US 2008/0135131 A1
(43) Pub. Date: Jun. 12, 2008

(54) Router guide for electrical box cutouts

(76) Inventor: Joseph A. Morin, New Hampton, NH (US)

Correspondence Address: LITMAN LAW OFFICES, LTD., P.O. BOX 15035, CRYSTAL CITY STATION, ARLINGTON, VA, 22215, US

(21) Appl. No.: 11/634,974

(22) Filed: Dec. 7, 2006

(51) Int. Cl. B27C 5/00

(52) U.S. Cl. 144/144.51

(57) ABSTRACT

The router guide for electrical box cutouts facilitates the forming of openings for electrical outlet and switch boxes and the like in a solid wall structure. The guide includes a template, which is temporarily secured to the wall structure and aligned with previously marked lines indicating the location of the previously formed conduit passages within the solid structure. The template includes one or more electrical box pattern openings formed therethrough. A router attachment plate is attached to a router, with the plate having a fixed collar concentric with the router bit. The router is used to cut the opening in the wall, with the collar of the router plate following the inner edge of the template pattern to form a precisely dimensioned opening for the installation of the electrical box therein. The router guide is particularly useful in log construction, but may be used with other solid structures as well.

### BACKGROUND OF THE INVENTION

1. Field of the Invention

The present invention relates generally to powered cutting tools. More specifically, the present invention relates to a router guide for electrical box cutouts, and a router attachment plate with a collar, which follows the wall-mounted template. The assembly is particularly useful in forming recesses for the installation of electrical outlet and switch boxes and the like in solid wall structures.

2. Description of the Related Art

Conventional procedure in the installation of electrical wiring, plumbing pipes, etc. in structures, is to locate such elements within the walls, ceiling and floor of the structure in order to conceal and protect them. This is easily accomplished in frame construction, as the space between the sheathing on each side of the frame structure provides sufficient room for such. It is only necessary to cut openings in the relatively thin sheathing for access and placement of electrical receptacle and light boxes, etc.

However, the work involved can be significantly greater in the case of a solid wall structure. While frame structures having space within the walls are in the majority, solid wall structures, such as log homes, are also popular among homebuilders. Solid wall structures can be formed of other materials as well, e.g., thick panels of foam plastic sandwiched between protective overlay sheets, or perhaps even poured concrete, with or without insulating panels on one or both surfaces.

In the case of poured concrete structures, electrical conduit and plumbing lines are generally installed when the concrete is poured, with various receptacles for outlet boxes and the like being formed at the same time. However, it is necessary to cut and drill these passages through the walls, in the case of log structures. Even after the passages have been drilled, it is then necessary to cut openings through the wall structure, with the openings positioned to communicate with the previously drilled passages. This is accomplished conventionally by drilling and manually chiseling out the material where the electrical box is to be located, following guide lines marked on the surface of the wall structure to indicate the location of the previously drilled concealed passages. Obviously, this entails hard and time consuming physical labor.

Thus, a router guide for electrical box cutouts solving the aforementioned problems is desired.

### SUMMARY OF THE INVENTION

The router guide for electrical box cutouts facilitates the cutting or forming of openings in solid wall structures for the installation of electrical outlet and switch boxes and the like. The router guide includes a guide plate or template having at least one electrical box pattern formed therein, and a router attachment plate having a collar concentric with the router bit. The router attachment plate is secured to the router and the template is attached to the wall (or other structure), aligned with guide lines previously marked on the surface to indicate the location of the underlying previously formed passages within the wall. The router is then operated to cut out the area within the template opening, with the router attachment plate collar following the inner edge of the template opening. The result is an accurately dimensioned opening in the solid wall structure, providing for the installation of an electrical outlet or switch box or the like therein.

These and other features of the present invention will become readily apparent upon further review of the following specification and drawings.

### BRIEF DESCRIPTION OF THE DRAWINGS

FIG. 1 is an environmental, perspective view of a router guide for electrical box cutouts according to the present invention, showing its operation and use.

FIG. 2 is a detailed perspective view of the router guide and router attachment plate according to the present invention secured on a router, showing their relationship during operation.

FIG. 3 is a side elevation view in partial section of a router guide according to the present invention, showing the installation of the template to a solid wall structure and the use of the router with its attached plate in the formation of a receptacle in the wall.

FIG. 4 is a front elevation view of an alternative embodiment of a router guide template for electrical box cutouts according to the present invention having two different patterns formed therein.

Similar reference characters denote corresponding features consistently throughout the attached drawings.

### DETAILED DESCRIPTION OF THE PREFERRED EMBODIMENTS

The present invention comprises a router guide for electrical box cutouts for use in accurately routing out openings or receptacles in solid wall structures for the installation of electrical outlet boxes, switch boxes, and the like therein. While the present invention is primarily directed for use in log home construction, it may be applied to other solid wall construction materials as well.

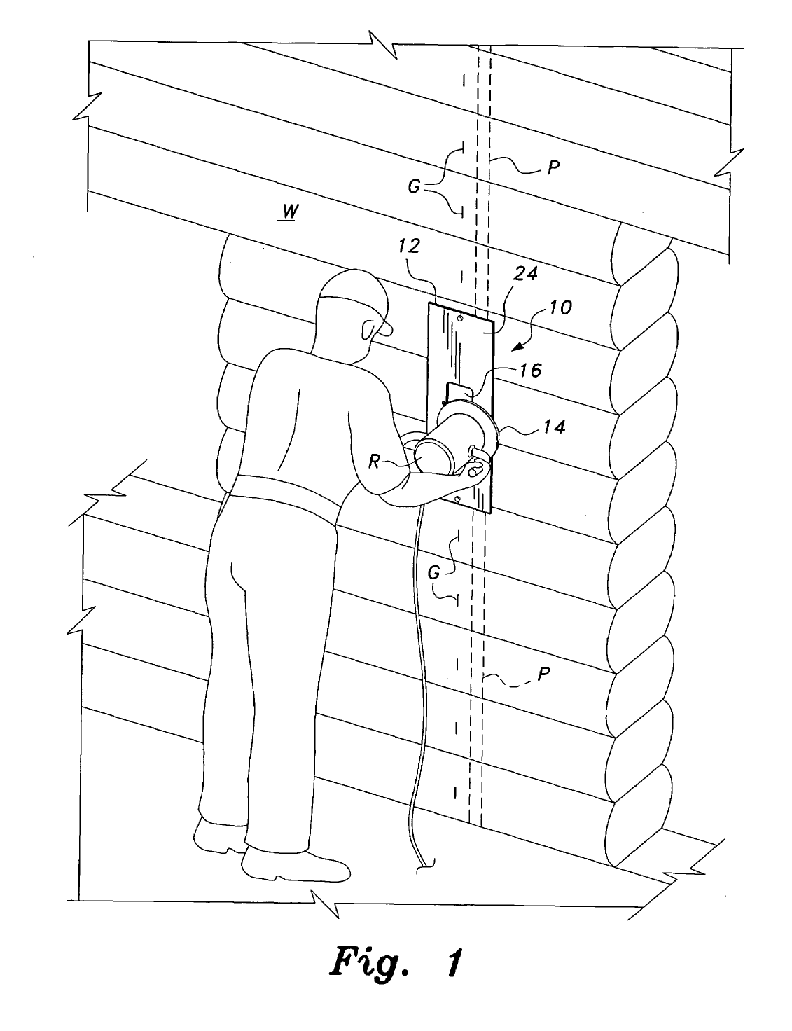

FIG. 1 of the drawings provides an environmental view of the operation of a first embodiment of the router guide assembly, designated as router guide assembly 10. The assembly 10 includes a cutout template 12, which is attached temporarily to the wall W of the structure, and a router attachment plate 14, which is attached to the router R. The template 12 includes a cutout pattern opening 16 formed therethrough, which is aligned with the desired area to be routed out by the router R. The opening 16 may be configured for the formation of any suitable hole or recess in the wall structure W, e.g., a two outlet “handy box,” a square, four outlet box, etc., as desired.

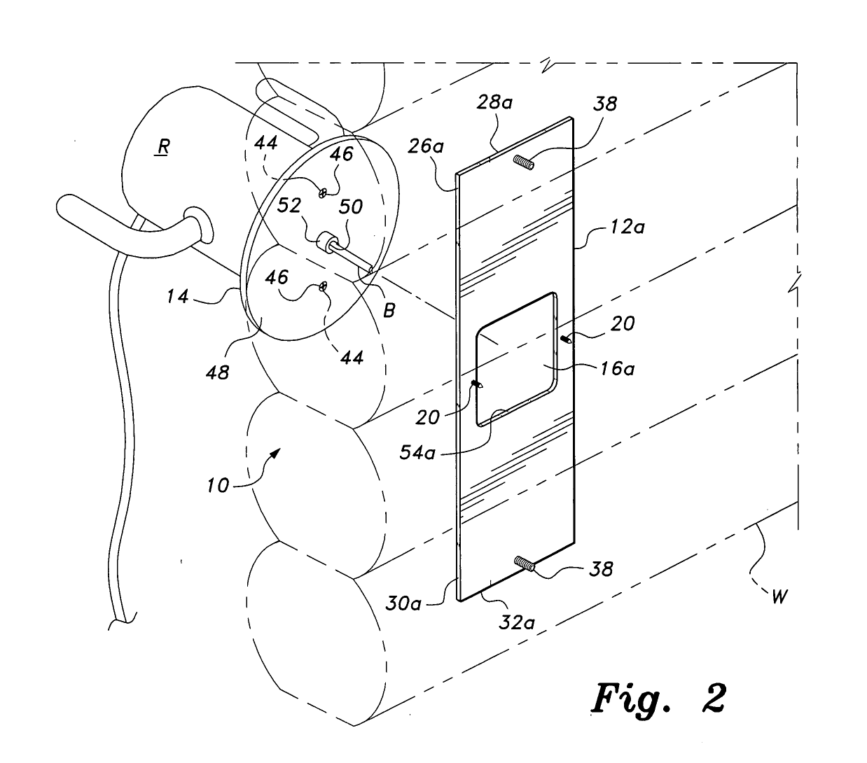

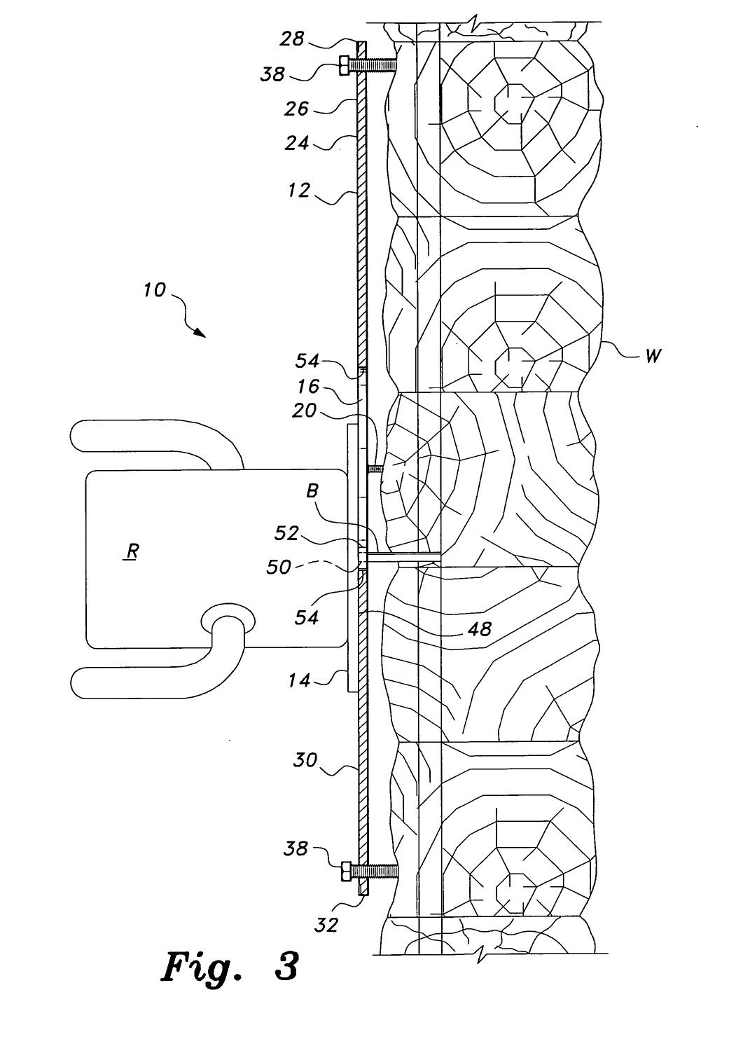

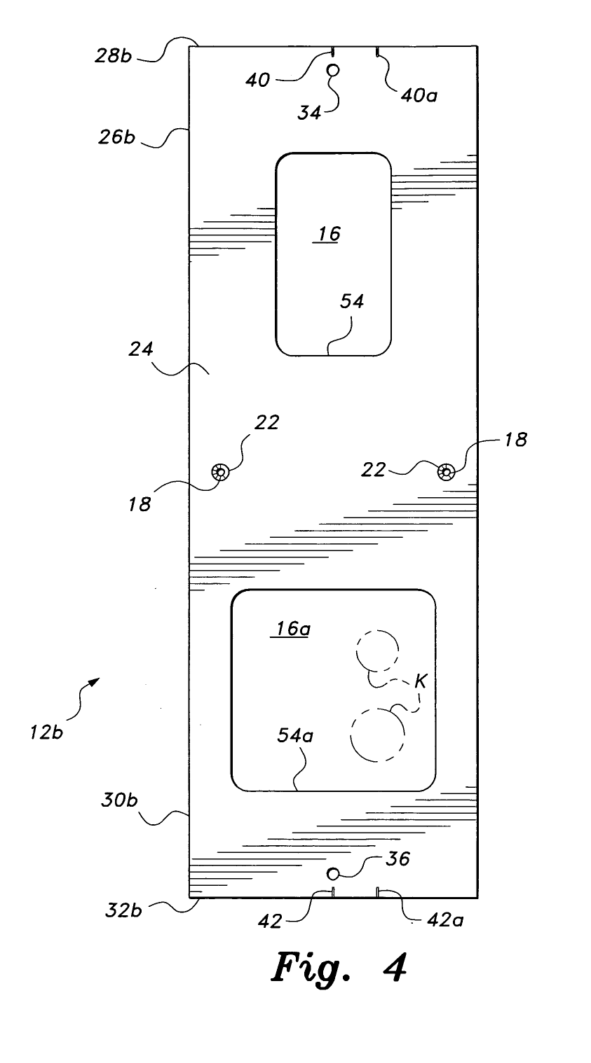

FIGS. 2 and 3 illustrate further details of the components comprising the assembly, with FIG. 2 illustrating an alternative assembly 10a having a cutout template 12a with a square box cutout pattern opening 16a. (The template 12a and router R with its attachment plate 14 are positioned to the same side, i.e., the back side, of the wall W in FIG. 2.) The template 12 or 12a (and the router attachment plate 14, as well) comprises a relatively thin, flat, planar, rigid sheet of material, e.g., a metal sheet, such as aluminum, although other materials may be used as desired. The various template embodiments each include a pair of laterally opposed fastener passages 18 formed therethrough, as shown in the alternative embodiment template 12b of FIG. 4. These fastener passages 18 provide for the installation of attachment screws 20 therethrough, as shown in FIGS. 2 and 3. The template 12 (or 12a, 12b, etc.) is temporarily attached to the wall structure W by the screws 20, generally as shown in FIG. 1, to hold the template securely in place during the routing operation. The passages 18 are provided with countersunk depressions 22 formed adjacent to the router plate contact surface 24 of the cutout template. This provides a smooth and uninterrupted router plate contact surface 24 when flat head screws are used, thus avoiding any interference with the movement of the router attachment plate 14 thereover.

The template 12 includes an upper portion 26 and edge 28, and an opposite lower portion 30 and edge 32. The respective components of the alternative template 12a are designated as 26a through 32a, with those respective components being designated as 26b through 32b for the template 12b of FIG. 4. The relatively long or tall configuration of the various templates 12 through 12b, results in the templates spanning a substantial distance over the surface of the wall W when installed thereon. This assists in leveling the template relative to the wall surface, when the wall W has an irregular or uneven surface as occurs in typical log structures. Fine adjustment of the plane of the templates relative to the wall W is provided by a first and a second leveling screw passage, respectively passages 34 and 36, as shown in the template 12B of FIG. 4. These passages are threaded to accept first and second leveling screws 38 therein, as shown in FIGS. 2 and 3 of the drawings. These leveling screws are threadibly advanced or retracted in their respective passages 34 and 36 to position the plane of the template parallel to the average plane of the surface of the wall structure W. The leveling screws 38 may also be used to space the cutout template 12, 12a, etc. from the wall W in order to set the depth of the router cut precisely as desired.

The selected template 12, 12a, 12b, etc. must be accurately positioned relative to the previously formed wiring (or plumbing, etc.) passage P concealed within the wall structure W, as shown in FIGS. 1 and 3. Accordingly, a guide line or series of guide marks G is conventionally placed upon the surface of the wall W directly over the concealed passage P to guide the worker forming the recesses or cutouts in the wall, as shown in FIG. 1 of the drawings. The cutout template includes opposed first and second alignment guide marks engraved or otherwise formed or marked upon the upper and lower portions of the template, respectively, adjacent the upper and lower edges thereof.

FIG. 4 provides an exemplary illustration of a template 12b having such first and second guide marks 40 and 42 formed in the router plate contact surface 24 of the template. The guide marks 40 and 42 define a guide line, which passes through the center of the smaller cutout pattern opening 16. This opening 16 is configured for cutting a recess for a conventional “handy box,” i.e., a two outlet or switch box having nominal dimensions of three inches high by two inches wide. The actual size of the cutout opening 16 is slightly larger to accommodate the router guide assembly, as discussed further below. Such outlet or switch boxes conventionally include various preweakened or “knockout plug” areas in their sides, tops, and backs, which may be punched out as required for the insertion of wiring into the box. Such smaller “handy box” size boxes conventionally have the top, bottom, and rear knockout areas formed concentrically with the vertical centerline of the box, thus allowing the guide marks 40 and 42 to be aligned accordingly on the template.

However, the cutout template 12b embodiment of FIG. 4 further includes a cutout opening 16a, for forming a recess for a larger four outlet box. Such electrical boxes conventionally have a substantially square configuration of four by four inches. However, the knockout plug areas in the backs of such larger square boxes are typically offset from the center of the box, with their locations typically being about as shown for the knockout plug indicator circles K shown in broken lines in FIG. 4. Accordingly, the upper and lower guide marks 40a and 42a for the larger cutout pattern opening 16a of the template 12b of FIG. 4, are offset laterally from the centerline of the template and aligned with a line passing through the centers of the two knockout plug indicator circles K shown in the lower cutout pattern opening 16a. Generally, any alignment marks provided should align with the location of one or more openings in the electrical box to be installed, according to the cutout opening selected for the desired box.

The router attachment plate 14 is shown in detail in FIGS. 2 and 3 of the drawings. The router attachment plate is formed of a relatively thin, flat, planar, and rigid sheet of material, e.g., aluminum, but other materials may be used as desired. The plate 14 is preferably circular in order to avoid any corners, which might interfere with maneuvering the router R during operation, but other non-circular shapes may be provided as desired. The router attachment plate 14 includes a pair of opposed countersunk router attachment passages 44 formed therethrough, with corresponding flat head machine screws 46 removably securing the plate 14 to the router R. The provision of countersunk passages 44 and flat head screws 46 provides a flat, unbroken plane for the cutout template contact surface 48 of the router attachment plate 14, thus assuring that the plate 14 will slide smoothly over the contact surface 24 of the cutout template 12 with its flush head attachment screws 20.

The plate 14 includes a router bit passage 50 formed therethrough, providing clearance for a rotary router bit B when the plate 14 is installed on the router R. A guide collar 52 extends from the router attachment plate 14, concentric with the router bit passage 50. The guide collar is configured and adapted to ride along and follow the periphery 54 of the cutout template opening or pattern 16 (or periphery 54a of the alternative opening 16a, etc.) when the router R is operated with the cutout template 12 to form a cutout in the solid wall structure W, generally as shown in FIGS. 1 and 3 of the drawings.

It will be noted that the cutout openings 16, 16a, etc. are slightly oversize relative to the actual dimensions of the electrical boxes for which they are formed. This is to allow for the radius of the guide collar 52 of the router attachment plate 14. For example, if the guide collar 52 has a diameter of ¾ inch, the radius is ⅜ inch. Thus, if the cutout opening 16, 16a is dimensioned to the same dimensions as the corresponding electrical box, the radius of the guide collar 52 as it rides along the periphery 54, 54a of the respective cutout opening will result in the periphery of the cutout being ⅜ inch inside the desired dimension. Accordingly, the peripheries 54, 54a of the cutout openings 16, 16a are enlarged by an amount equal to the radius of the guide collar 52, e.g., a ⅜ inch larger dimension (¾ inch larger in total span across the cutout opening) for a ⅜ inch radius (¾ inch diameter) guide collar. The radii of the corners of the cutout openings may be equal to or less than the radius of the guide collar 52, in order to form a relatively sharp corner (equal to the radius of the router bit B) for the cutouts formed in the wall structure W. Additional radii may be added to the corners of the cutout openings 16a, 16b as desired, with the final radii of the corners of the wall cutouts being equal to the radii of the cutout openings 16a, 16b and the radius of the router bit B.

In conclusion, the router guide for electrical box cutouts in its various embodiments greatly facilitates the formation of a cutout for an electrical box or the like in a solid wall structure, greatly reducing the manual labor required for the conventional formation of such a cutout. The worker need only align the guide marks of the cutout template with previously marked guide lines on the wall, and temporarily secure the template in place. Precise leveling and spacing of the template relative to the wall is achieved by adjusting the leveling screws provided in the template. The router attachment plate is secured to the face of the router, with the router bit extending through the router bit passage and guide collar.

Depending upon the router bit configuration, a starter hole may be drilled in the wall structure, within the selected cutout pattern opening of the template. (This step may not be required if the router bit is capable of forming a starter hole.) The worker need only operate the router with the router plate in contact with the contact surface of the template and with the guide collar of the router attachment plate following or riding along the periphery of the pattern cutout opening to quickly and easily form an ideally dimensioned electrical box cutout in the solid wall structure.

It is to be understood that the present invention is not limited to the embodiments described above, but encompasses any and all embodiments within the scope of the following claims.

1. A router guide for use with a router in making electrical box cutouts in a solid wall structure, comprising:
a thin, flat, planar, rigid cutout template having a router attachment plate contact surface, the template defining at least one cutout pattern opening therethrough, the opening having a periphery;
a router attachment plate having a router bit passage therethrough; and
a guide collar extending from the router attachment plate concentric to the router bit passage, the guide collar being adapted to follow the periphery of the cutout template pattern when the router is operated with the cutout template to form a cutout in the solid wall structure, wherein the cutout template has an upper portion, an upper edge, a lower portion, and a lower edge, the upper portion and the lower portion and the respective upper and lower edges associated therewith being longitudinally opposed, each with respect to the other, the router guide further comprising:
a first alignment guide mark disposed upon the upper portion of the template adjacent the upper edge thereof; and
a second alignment guide mark disposed upon the lower portion of the template adjacent the lower edge thereof.

2. (canceled)

3. The router guide according to claim 1, wherein the cutout template has an upper portion, an upper edge, a lower portion, and a lower edge, the router guide further comprising:
first and second leveling screw passages disposed through the upper portion and the lower portion of the cutout template, respectively; and
a first and a second leveling screw threadibly and adjustably installed respectively through the first and second leveling screw passages.

4. The router guide according to claim 1, wherein the cutout template has at least two mutually laterally opposed fastener passages defined therethrough, the fastener passages including a countersunk depression adjacent the router plate contact surface of the cutout template.

5. The router guide according to claim 1, wherein said at least one opening comprises a first cutout pattern opening and a second cutout pattern opening separate from the first cutout pattern opening.

6. The router guide according to claim 1, wherein the router attachment plate further includes at least two generally opposed countersunk router attachment passages disposed therethrough.

7. (canceled)

8. A router guide for use with a router m making electrical box cutouts in a solid wall structure, comprising:
a thin, flat, planar, rigid cutout template having an upper portion, an upper edge, a lower portion, a lower edge, and a router plate contact surface, the template defining at least one cutout pattern opening through the template, the cutout pattern opening having a periphery,
wherein the upper portion and the lower portion and the respective upper and lower edges associated therewith are longitudinally opposed, each with respect to the other, the router guide further comprising:
a first alignment guide mark disposed upon the upper portion of the template adjacent the upper edge thereof: and
a second alignment guide mark disposed upon the lower portion of the template adjacent the lower edge thereof.

9. The router guide according to claim 8, further comprising:
a router attachment plate having a router bit passage defined therethrough; and
a guide collar extending from the router attachment plate concentric to the router bit passage, the guide collar being adapted to follow the periphery of the cutout template pattern when the router is operated with the cutout template to form a cutout in the solid wall structure.

10. The router guide according to claim 9, wherein the router attachment plate further includes at least two generally opposed countersunk router attachment passages disposed therethrough.

11. The router guide according to claim 8, further comprising:
first and second leveling screw passages, respectively, disposed through the upper portion and the lower portion of the cutout template; and
a first and a second leveling screw threadibly and adjustably installed through the first and second leveling screw passages, respectively.

12. The router guide according to claim 8, wherein the cutout template has at least two mutually laterally opposed fastener passages defined therethrough, the fastener passages each having a countersunk depression adjacent the router plate contact surface of the cutout template.

13. (canceled)

14. A router guide for use with a router in making electrical box cutouts in a solid wall structure, comprising:
a cutout template defining at least one cutout pattern opening therethrough, the opening having a periphery;
a router attachment plate having a router bit passage defined therethrough, the router attachment plate having at least two generally opposed countersunk router attachment passages extending through the plate; and
a guide collar extending from the router attachment plate concentric to the router bit passage, the guide collar being adapted to follow the periphery of the cutout template pattern opening when the router is operated with the cutout template to form a cutout in the solid wall structure, wherein the cutout template has an upper portion, an upper edge, a lower portion, and a lower edge, the upper portion and the lower portion and the respective upper and lower edges associated therewith being longitudinally opposed, each with respect to the other, the router guide further comprising:
a first alignment guide mark disposed upon the upper portion of the template adjacent the upper edge thereof; and
a second alignment guide mark disposed upon the lower portion of the template adjacent the lower edge thereof.

15. (canceled)

16. The router guide assembly according to claim 14, wherein the cutout template comprises a thin, flat, planar, rigid panel having a router attachment plate contact surface.

17. The router guide according to claim 14, wherein the cutout template has an upper portion, an upper edge, a lower portion, and a lower edge, the guide further comprising:
first and second leveling screw passages, respectively, disposed through the upper portion and the lower portion of the cutout template; and
a first and a second leveling screw, respectively, threadibly and adjustably installed through the first and the second leveling screw passages.

18. The router guide according to claim 14, wherein the cutout template has a router plate contact surface and at least two mutually laterally opposed fastener passages extending through the template, the fastener passages including a countersunk depression adjacent the router plate contact surface of the cutout template.

19. The router guide according to claim 14, wherein said at least one opening comprises a first cutout pattern opening and a second cutout pattern opening separate from the first cutout pattern opening.

20. (canceled)

21. The router guide according to claim 2, wherein said template is elongated and includes a longitudinal axis bisecting said at least one cutout pattern opening, said longitudinal axis further being in alignment with said first and second alignment marks.

22. The router guide according to claim 8, wherein said template is elongated and includes a longitudinal axis bisecting said at least one cutout pattern opening, said longitudinal axis further being in alignment with said first and second alignment marks.

23. The router guide according to claim 16, wherein said template is elongated and includes a longitudinal axis bisecting said at least one cutout pattern opening, said longitudinal axis further being in alignment with said first and second alignment marks.

24. The router guide according to claim 23, wherein said router guide further comprising:
a third alignment guide mark disposed on the upper portion of the template adjacent the upper edge thereof and laterally offset from said first alignment mark; and
a fourth alignment guide mark disposed on the lower portion of the template adjacent the lower edge thereof and laterally offset from said second alignment mark.
